(19) United States
(12) Patent Application Publication
(10) Pub. No.: US 2006/0088415 A1
(43) Pub. Date: Apr. 27, 2006

(54) Deployable lighter-than-air wind rotor for intermittent wind loads

(76) Inventor: Guy Gadola III, Sharpsville, PA (US)

Correspondence Address: Guy P. Gadola, III, 4060 Sararac Dr., Sharpsville, PA, 16150, US

(21) Appl. No.: 10/851,970

(22) Filed: May 24, 2004

(51) Int. Cl. F03B 17/06

(52) U.S. Cl. 416/84

(57) ABSTRACT

A deployable lighter-than-air wind rotor for intermittent wind loads consists of inflatable blades attached to a tether via a hub. The tether is fixed to the hub. Inflated and sent aloft during windy conditions, the rotor (blades and hub) twists the tether to transmit rotational force to the tether's power-take-off. When the wind subsides, the rotor is reeled-in for storage.

### FIELD OF INVENTION

This invention generally relates to wind turbines and lighter-than-air balloons.

### BACKGROUND OF INVENTION

Most of the optimum sites for wind-power generation today are those sites with nearly constant wind speed above a certain threshold (e.g. 10 m.p.h.). Permanent towers are built and wind turbines are erected at some of those sites. (The visual and auditory impact or traditional towers and wind turbines rule out some sites.)

Other sites have sporadic wind speeds. Wind speeds at those sites may surpass the currently recognized lower limits for wind power generation (e.g. 7 m.p.h.) only a few days a month and surpass current upper limits (e.g. 30 m.p.h.) a few days a year.

Those sporadic conditions can be harnessed by a device that is easily deployable, retractable, adjustable, and transportable. The object of this invention is to provide those qualities.

U.S. Pat. No. 6,616,402 offers a good discussion of some background aspects of this invention related to tower usage. Embodiment 67 of U.S. Pat. No. 6,616,402 is similiar to this present device. In some sence, this present invention, uses a tether instead of a tower. Thus, this present invention improves upon U.S. Pat. No. 4,207,026. This present device uses additional inflation to compensate for higher wind speeds. This present invention is needed since it is easily deployable, retractable, adjustable, and transportable.

### SUMMARY OF INVENTION

The ability to be deployed, retracted, adjusted, transported and other abilities are achieved generally in this invention by offering an inflatable body and spool-able tether. The invention improves upon known lighter-than-air wind turbines by using a speedometer-cable-like tether. Thus, the wind rotor can continue to turn while being reeled in or reeled out. This invention offers a flexible deployment and retraction scheme that known wind turbines do not.

Towers are typically meant to provide permanent roosts for wind turbines. (Construction cranes do have a more temporary tower-like function than typical wind-turbine towers. However, construction cranes are not as easy to deploy as this invention's lighter-than-air method.) This invention is designed to be raised temporarily into passing higher-wind conditions and retracted after the relatively windy conditions subside.

Many known wind turbines are designed to de-furl in extremely windy conditions. This invention surpasses those known turbines by its ability to be inflated to a size appropriate to conditions typically above known wind turbine operation (e.g. 30 m.p.h.). The ability of this invention to be adjusted and thus harness higher wind conditions is an advantage over many known wind turbines. The flexibility of the inflatable rotor's material offers resistance to shocks and strains that accompany extreme wind conditions. This invention is forgiving to extreme wind conditions.

This invention is optimized for transportation to windy conditions. Since this invention can be deflated, it provides easy storage for transportation to known windy areas. For example, the landfall of tropical storms are predicted within sufficient accuracy and lead-time to allow this invention to be transported to the landfall zone and deployed.

### BEST MODE FOR CARRYING OUT INVENTION

Since the invention is similar to a kite, the best mode for operating this invention is in areas best suited for operating a kite. The area should be free from electrical transmission lines, flight paths, trees, etc.

The tether should have a lubricated outer cover similar to that of a speedometer cable to allow the tether to be reeled and unreeled while rotating. The power-take-off should be connected to a device that uses rotational energy to operate, such as a fan, compressor, electrical generator, and flywheel.

Since this present device is an improvement of the known device described in U.S. Pat. No. 4,207,026 patents using other known devices, namely a reel and speedometer cable, no new drawings are included in this disclosure.

### PREFERRED EMBODIMENTS

A preferred embodiment of this invention is the eggbeater style. This vertical-axis design can have three-blades to add stability over a two-bladed design. Those skilled in the art of vertical-axis wind turbines should consult experts in inflatable helium airships and balloons to determine the proper blade-ratios.

Another preferred embodiment of this invention is the Savonius style. This style exhibits the “magnus principal”, which pulls the convex portion of the device into the wind. As with the above embodiment, those skilled in the art of building vertical-axis wind turbines should consult experts in inflatable helium airships and balloons to determine the proper ratios.

### INDUSTRIAL APPLICABILITY

The invention is useful where windy conditions exist only several days each year. Its spool allows easy deployment and retractions. Its inflatable blades allow easy storage. Its low mass allows and low storage requirements facilitate its transportation.

That which is claimed is:

1. A lighter-than-air wind rotor system comprising:
an inflatable wind rotor,
a speedometer cable-like tether,
lifted by a lighter-than-air buoyancy.

2. The device of claim 1, wherein the rotor's size can be adjusted through inflation in direct proportion to wind speed.

3. The device of claim 1, wherein the speedometer cable-like tether is wrapped around a ground-based reel.
